(19) United States
(12) Patent Application Publication
(10) Pub. No.: US 2015/0302970 A1
(43) Pub. Date: Oct. 22, 2015

(54) Magnetic Core

(71) Applicants: Yen-Wei Hsu, Taipei (TW); Whei Chyou Wu, Fremont, CA (US)

(72) Inventors: Yen-Wei Hsu, Taipei (TW); Whei Chyou Wu, Fremont, CA (US)

(21) Appl. No.: 14/254,899

(22) Filed: Apr. 17, 2014

(51) Int. Cl. H01F 27/255

(52) U.S. Cl. CPC H01F 27/255

(57) ABSTRACT

The invention relates to a magnetic core, and more particularly, to a magnetic switch, a magnetic amplifier and an inductor based on the magnetic core.

### BACKGROUND OF THE INVENTION

1. Field of Invention

The invention relates to a magnetic core, and more particularly, to a magnetic switch, a magnetic amplifier and an inductor based on the magnetic core.

2. Description of Related Art

Insulated-gate bipolar transistor (IGBT) is a three-terminal power semiconductor device primarily used as an electronic switch. The prior-art IGBT has drawbacks: (1) the junction of IGBT is weak against big electrical power flowing through it and the problem is getting worse for continous big electrical power, (2) a waveform applied on the gate of IGBT to control on/off of the IGBT will be modulated into the electrical power flowing through the IGBT as a noise, (3) it's difficult to precisely turn on or off an IGBT, (4) a serious heat will be accumulated in the IGBT and the heat dissipation is critical, (5) IGBT is expensive, and (6) a waveform applied on the gate of IGBT to control the IGBT usually has negative voltage components causing many potential problems and design difficulties.

Aiming to solve the drawbacks of IGBT above, an inventive magnetic switch is revealed in the present invention. The inventive magnetic switch is based on an inventive magnetic core which is also revealed in the present invention. An inventive magnetic amplifier based on the inventive magnetic core is also revealed in the present invention. A conductive coil winding around the inventive magnetic core also reveals an inventive inductor. An inventive manufacturing method to manufacture the inventive magnetic core is revealed in the present invention.

### BRIEF SUMMARY OF THE INVENTION

An inventive magnetic core is revealed in the present invention.

An inventive magnetic switch based on the inventive magnetic core is revealed in the present invention.

An inventive magnetic amplifier based on the inventive magnetic core is revealed in the present invention.

A conductive coil winding around the inventive magnetic core reveals an inventive inductor in the present invention.

An inventive manufacturing method to manufacture the inventive magnetic core is revealed in the present invention.

### BRIEF DESCRIPTION OF THE SEVERAL VIEWS OF THE DRAWINGS

FIG. 1 has shown an example of a BH curve having zero area;

FIG. 2 has shown an example of a BH curve having an area;

FIG. 3(A) has shown an embodiment of BH curves respectively of a plurality of same-saturation-level magnetic layers;

FIG. 3(B) has shown an embodiment of BH curves respectively of a plurality of same-applied-force magnetic layers;

FIG. 4 has shown the BH curves respectively of the c same-saturation-level magnetic layers of FIG. 3(A) and the BH curves respectively of the g same-applied-force magnetic layers of FIG. 3(B) with the highest applied force H of the BH curves respectively of the c same-saturation-level magnetic layers is same to the applied force H of the BH curves respectively of the g same-applied-force magnetic layers or H_{c}=Hₚ;

FIG. 5(A) has shown an embodiment of two cylindrical multilayer magnetic cores stacked together in side view. FIG. 5(A) and

FIG. 5(B) is the top view of FIG. 5(A);

FIG. 6(A) has shown an embodiment of a smaller cylindrical multilayer magnetic core disposed inside a larger cylindrical multilayer magnetic cores in side view;

FIG. 6(B) is the top view of FIG. 6(A);

FIG. 7(A) has shown an embodiment of an inventive magnetic switch;

FIG. 7(B) has shown an embodiment of an inventive magnetic switch;

FIG. 8(A) has shown an embodiment of an inventive magnetic amplifier;

FIG. 8(B) has shown an embodiment of an inventive magnetic amplifier;

FIG. 9(A) has shown a container in top view;

FIG. 9(B) is a side view of the container of FIG. 9(A);

FIG. 10 has shown an embodiment of a m-layer multilayer device in side view;

FIG. 11(A) has shown an embodiment of a rectangular closed-loop m-layer multilayer device in top view based on the m-layer multilayer device of FIG. 10;

FIG. 11(B) has shown an embodiment of a oval-shaped closed-loop m-layer multilayer device in top view based on the m-layer multilayer device of FIG. 10;

FIG. 11(C) has shown an embodiment of a ring-shaped or round closed-loop m-layer multilayer device in top view based on the m-layer multilayer device of FIG. 10;

FIG. 12(A) has shown an embodiment of an I-shaped m-layer multilayer device in top view based on the m-layer multilayer device of FIG. 10;

FIG. 12(B) has shown an embodiment of a C-shaped m-layer multilayer device in top view based on the m-layer multilayer device of FIG. 10; and

FIG. 12(C) has shown an embodiment of an E m-layer multilayer device in top view based on the m-layer multilayer device of FIG. 10.

### DETAILED DESCRIPTION OF THE INVENTION

Reviewing the Faraday's induction law,

$$V = L \frac{d i}{d t}$$

where V is a voltage across an inductor, L is inductance of the inductor and i is current flowing through a conductive coil of the inductor.

An electrical energy stored in the inductor can be described as

$$E = \frac{1}{2} L {i}^{2}$$

Faraday's induction law above can also be described as

$$V = ( \frac{L}{a} ) ( \frac{a d i}{d t} )$$

If a>1, then

$$\frac{L}{a}$$

is smaller than L meaning the inductance of the inductor becomes smaller. If L of the inductor changes to

$$\frac{L}{a} ,$$

then

$$\frac{d i}{d t}$$

changes to

$$\frac{a d i}{d t}$$

according to equation

$$V = L \frac{d i}{d t} = ( \frac{L}{a} ) ( \frac{a d i}{d t} )$$

for the same inductor and electrical energy stored in the capacitor becomes

$$\begin{matrix}{E}_{2} = \frac{1}{2} ( \frac{L}{a} ) {( a i )}^{2} \\ = a ( \frac{1}{2} L {i}^{2} ) \\ = a {E}_{1} > {E}_{1}\end{matrix}$$

such that the stored energy becomes larger if a>1 or the inductance L becomes smaller. An inductor can be viewe as an electrical amplifier with the inductance drop. The bigger inductance drops, the more electrical power are generated.

Seen in some magnetic materials, a magnetic saturation is the state reached when an increase in applied external magnetic field H can not increase the magnetization of the material further, so the total magnetic flux density B levels off. It is a characteristic particularly of ferromagnetic materials, such as iron, nickel, cobalt and their alloys.

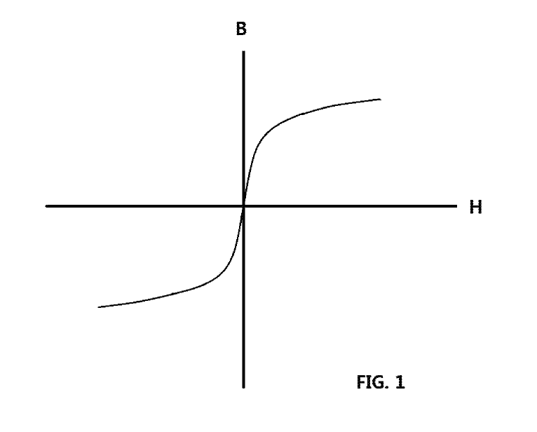

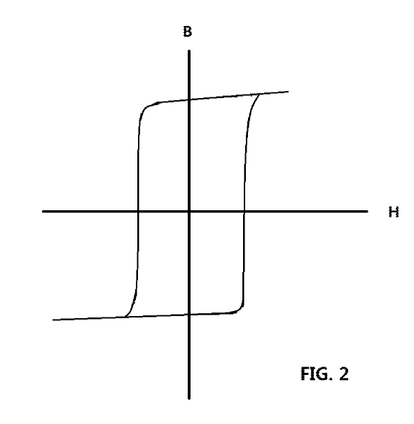

Magnetic saturation (or simply called “saturation” in the present invention) is most clearly seen in the magnetization curve (also called BH curve or hysteresis curve) of a substance, as a bending to the right of the curve as seen in examples of FIG. 1 and FIG. 2. As the H field increases, the B field approaches a maxmum value asymptotically, the saturation level for the substance.

A multilayer device with any shape can be formed by a plurality of layers or m layers for m≧2 stacked together with one layer laying or forming on another layer and any two layers of the multilayer device can have a same thickness or different thicknesses.

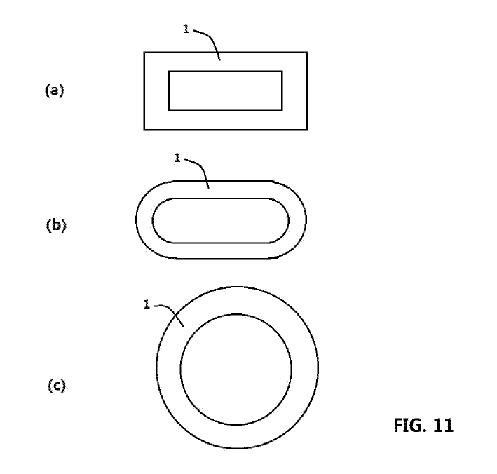

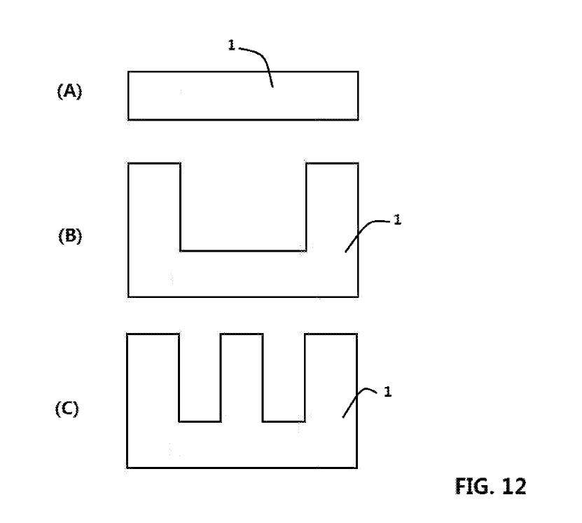

FIG. 10 has shown a m-layer multilayer device in side view formed by a plurality of layers or m layers for m≧2 stacked together with one layer laying or forming on another layer. The m-layer multilayer device of FIG. 10 is not limited to any particular shape and can be in closed-loop or open-loop. For example, the m-layer multilayer device of FIG. 10 in top view can be in ring or round closed-loop as shown in FIG. 11(C), oval-shaped closed-loop as shown in FIG. 11(B), rectangle or square closed-loop as shown in FIG. 11(A), etc. For example, the m-layer multilayer device of FIG. 10 in top view can be in I-shaped open-loop as shown in FIG. 12(A), E-shaped open loop as shown in FIG. 12(C), C-shape or U-shaped open-loop as shown in FIG. 12(B), etc.

The m-layer multilayer device described above is an inventive multilayer magnetic core if the m layers of the m-layer multilayer device have n magnetic layers.

The m and the n can be equal or different. The m and the n are equal meaning all the layers of the m-layer multilayer device are magnetic layers. The m is larger than the n meaning only a portion of the m layers are magnetic layers and the rest of the m layers are not magnetic layers. For example, any two neighboring magnetic layers can be electrically isolated by disposing an electrical isolator layer between the two neighboring magnetic layers if the electrical isolation between two magnetic layers is considered. For another example, the multilayer magnetic core can be strengthened by epoxy in the manufacturing process and liquid epoxy in the manufacturing process can possibly infiltrate into two magnetic layers in the form of a layer when dried, which can be viewed as a layer seated between two magnetic layers. If epoxy is an electrical insulator, then it can also function as an electrical isolator. The discussion reveals the multilayer magnetic core allows layer other than magnetic layer.

A first saturation of any magnetic layer of the inventive multilayer magnetic core will result in the increase of current flowing through a conductive coil winding around the multilayer magnetic core and the inductance drop of the inventive multilayer magnetic core. The increasing current will easier trigger a second saturation of a second magnetic layer resulting in the further increase of current flowing through the conductive coil. The increasing current will further easier trigger a third saturation of a third magnetic layer resulting in the increase of current flowing through the conductive coil. Current flowing through the conductive coil will become bigger and bigger through the multiple saturations one after another. When all the magnetic layers of the multilayer magnetic core are saturated, the inductance of the conductive coil winding around the multilayer magnetic core will drop to zero in theory to obtain the biggest current flowing through the conductive coil at that moment.

When only a portion of the magnetic layers of the multilayer magnetic core are saturated by a current flowing through a conductive coil winding around the multilayer magnetic core or a nearby magnetic field, then the multilayer magnetic core is called partial-saturation magnetic core in the present invention. When all the magnetic layers of the multilayer magnetic core are saturated by a current flowing through a conductive coil winding around the multilayer magnetic core or a nearby magnetic field, then the multilayer magnetic core is called full-saturation magnetic core in the present invention.

Our previous patent “an inductor” with its application Ser. No. 13/193,620, filed on 29 Jul. 2011 also discussed about multilayer magnetic core for your reference.

French physicist Louis Neel discovered in 1949 that materials ferromagnetic finely divided nanoparticle lose their hysteresis below a certain size Louis Neel critical. This phenomenon is called super-paramagnetism. Superparamagnetism occurs in nanoparticles which are single-domain, i.e. composed of a single magnetic domain. This is possible when their diameter is below 3-50 nm, depending on the materials. For conveniece, the material can be called “superparamagnetic material” in the present invention. The magnetization of these materials is according to the applied field which is highly non-linear and its BH curve has zero area as shown in an example of a graph in FIG. 1. The Neel effect appears when a superparamagnetic material placed within a conducting coil is subjected to varying frequencies of magnetic fields. The non-linearity of the superparamagnetic material acts like a frequency mixer. The voltage measured at the coil terminals then comprises several frequential components, not only at initial frequencies, but also at some of certian linear combinations thereof. Therefore, the frequency shift of the field to be measured allows for the detection of a DC field using a standard coil.

Area of BH curve of a magnetic material expresses the capability of energy stored in the magnetic material. Bigger area expresses bigger energy can be stored in the magnetic material. A slim BH curve of a magnetic material has less capability of energy stored in the magnetic material. A magnetic material with its BH curve having zero area as a superparamagnetic material has featured to have no energy stored capability but to have very quick response to even a very small applied force such as a very small DC.

Different materials have different saturation levels but different materials under different manufacturing processes such as different annealings can possibly have a same saturation level.

A same material in different grain sizes below a certain size Louis Neel critical have different BH curve areas from each other with a same satuartion level, in other words, the BH curves respectively of a same material in different grain sizes below a certain size Louis Neel critical respectively have a same saturation level B and different applied magnetization forces (or simply “applied force” in the present invention) Hs from each other. The smaller grain size is, the smaller applied force is. The material is not limited to any particular material in any form, for example, it can be a pure metal, a binary alloy, a tenary alloy, a compositionally modulated alloy, a metal matrix composite, ceramic, or a ceramic nanocomposite.

To control the saturations of the multilayer magnetic core is a key to control the inductance drop of the multilayer magnetic core. To precisely control the saturations of the multilayer magnetic core is a key to precisely control the inductance drop of the multilayer magnetic core. The present invention has revealed an inventive multilayer magnetic core to reach the goal.

The BH curves respectively of a plurality of magnetic layers of a multilayer magnetic core can have a same saturation level B with different applied magnetization forces H from each other. The BH curve of each of the plurality of magnetic layers is not limited to any particular shape or form. More square BH curve features quicker response with less delay. Square BH curve advantages for immediate response in zero-wait.

For example, the BH curves respectively of a plurality of magnetic layers of a multilayer magnetic core are shown in FIG. 3(A), for convenience, assuming the plurality of magnetic layers respectively have a square or rectangular BH curve to keep the drawing simple and clean for easier reading and explanation although the present invention is not so limited. FIG. 3(A) has shown c magnetic layers respectively have a first BH curve 301 having a Bₜ and a H₁, a second BH curve 302 having the Bₜ and a H₂, a third BH curve 303 having the Bₜ and a H₃, a fourth BH curve 304 having the Bₜ and a H₄, a fifth BH curve 305 having the Bₜ and a H₅, and so on to a c^{th} BH curve having the Bₜ and a H_{c}. All the c magnetic layers are alternately drawn in thin- and bold-line squares for easier reading. The c magnetic layers of FIG. 3(A) are called same-saturation-level magnetic layers in the present invention. In practice, the same saturation level has an allowable varying range. An embodiment, according to Louis Neel, the c magnetic layers can be respectively formed with or by a same material respectively in different grain sizes below a certain size Louis Neel critical from each other.

The BH curves respectively of a plurality of magnetic layers of a multilayer magnetic core can have different saturation levels Bₛ from each other respectively by a same expected applied force Hₚ. The BH curve of each of the plurality of magnetic layers is not limited to any particular form. More square BH curve features quicker response with less delay. Square BH curve advantages for immediate response in zero-wait.

For example, the BH curves respectively of a plurality of magnetic layers of a multilayer magnetic core are shown in FIG. 3(B), for convenience, assuming the plurality of magnetic layers respectively have a square or rectangular BH curve to keep the drawing simple and clean for easier reading and explanation although the present invention is not so limited. FIG. 3(B) has shown d magnetic layers respectively have a first BH curve 401 having a B₁ and a Hₚ, a second BH curve 402 having a B₂ and the Hₚ, a third BH curve 403 having a B₃ and the Hₚ, a fourth BH curve 404 having a B₄ and the Hₚ, and so on to a d^{th} BH curve having a B_{d} and the Hₚ. All the d magnetic layers are alternately drawn in thin- and bold-line squares for easier reading. The d magnetic layers of FIG. 3(B) are called same-applied-force magnetic layers in the present invention. In practice, the same applied force has an allowable varying range. As discussed earlier, different materials have different saturation levels, an embodiment, the d magnetic layers can be respectively formed with or by different materials from each other.

The m-layer multilayer device for m≧2 described above is an inventive multilayer magnetic core if the m layers of the m-layer multilayer device have n magnetic layers for n≧2 and c same-saturation-level magnetic layers for c≧2, where the same-saturation-level magnetic layer is a magnetic layer. The BH curve of each of the c same-saturation-level magnetic layers is not limited to any particular form, for example, it can be a rectangular or a non-rectangular BH curve. In practice, the same saturation level of the c same-saturation-level magnetic layers has an allowable varying range.

The m and the n can be equal or different. The m and the n are equal meaning all the layers of the m-layer multilayer device are magnetic layers. The m is larger than the n meaning only a portion of the m layers of the m-layer multilayer device are magnetic layers and the rest of the m layers are not magnetic layers. For example, any two neighboring magnetic layers can be electrically isolated by disposing an electrical isolator layer between the two neighboring magnetic layers if the electrical isolation between two magnetic layers is considered. For another example, the multilayer magnetic core can be strengthened by epoxy in the manufacturing process and liquid epoxy in the manufacturing process can possibly infiltrate into two magnetic layers in the form of a layer when dried, which can be viewed as a layer seated between two magnetic layers. If epoxy is an electrical insulator, then it can also function as an electrical isolator. The discussion reveals the first multilayer magnetic core allows layer other than magnetic layer.

The n and the c can be equal or different. The n and the c are equal meaning all the magnetic layers are same-saturation-level magnetic layers. The n is larger than the c meaning only a portion of the n magnetic layers are same-saturation-level magnetic layers and the rest of the n magnetic layers are not same-saturation-level magnetic layers or non-same-saturation-level magnetic layer such as any prior-art magnetic layer, for example, the BH curves respectively of any two non-same-saturation-level magnetic layers have different Bs and different Hs.

When a current from zero provided by a very small electrical power source trying to flow through a conductive coil winding around the inventive multilayer magnetic core has more difficulty to overcome the inductive resistance of the conductive coil so that initially a plurality of intensive saturation attempts one by one in a row can be helpful to gradually jump its current through the multiple saturations. This explains that FIG. 3(A) has also shown more intensive slim BH curves respectively of the c same-saturation-level magnetic layers seen around the center of the B-H coordinates. The intensively multiple saturations one after another jump the current having more capability to overcome the initial inductance resistance.

A first embodiment of the inventive multilayer magnetic core for m=n=c, The multilayer magnetic core of the first embodiment is called a first multilayer magnetic core in the present invention.

A second embodiment of the inventive multilayer magnetic core for m>n and n=c, The multilayer magnetic core of the second embodiment is called a second multilayer magnetic core in the present invention.

A third embodiment of the inventive multilayer magnetic core for m>n and n>c. The c same-saturation-level magnetic layers respectively can have a BH curve with a small H and B and small BH curve area featuring to provide sensitivity but small power capability. The magnetic layer or magnetic layers other than the c same-saturation-level magnetic layers with each having BH curve with larger area can be used to construct a considerate core volume capable of transforming into bigger power so the inventive multilayer magnetic core advantages for having both high sensitivity and high power capability. The multilayer magnetic core of the third embodiment is called a third multilayer magnetic core in the present invention. The third multilayer magnetic core can be a partial-saturation magnetic core or a full-saturation magnetic core.

A fourth embodiment based on the first multilayer magnetic core, the c same-saturation-level magnetic layers have at least a magnetic layer having a zero-area BH curve such as a superparamagnetic material. According to Louis Neel, any applied force on the superparamagnetic material will induce frequency components that will induce extra magnetic fluxes flowing in the multilayer magnetic core to help ease the demand from the applied force. The superparamagnetic material layer advantages to have very quick response to even a very small power source that includes a very small DC power. A very small power source such as a small DC can first saturate the uperparamagnetic material and lead to a chain of all the immediate multiple saturations. In other words, a very small power that includes small DC power source is capable of saturating all the c same-saturation-level magnetic layers. The first multilayer magnetic core of the fourth embodiment is called a fourth multilayer magnetic core in the present invention.

A fifth embodiment based on the second multilayer magnetic core, the c same-saturation-level magnetic layers have at least a magnetic layer having a zero-area BH curve such as a superparamagnetic material. The second multilayer magnetic core of the fifth embodiment is called a fifth multilayer magnetic core in the present invention.

A sixth embodiment based on the third multilayer magnetic core, the c same-saturation-level magnetic layers have at least a magnetic layer having a zero-area BH curve such as a superparamagnetic material. The third multilayer magnetic core of the sixth embodiment is called a sixth multilayer magnetic core in the present invention.

A seventh embodiment based on the first multilayer magnetic core, each of the c same-saturation-level magnetic layers has a rectangular BH curve. The first multilayer magnetic core of the seventh embodiment is called a seventh multilayer magnetic core in the present invention.

An eighth embodiment based on the second multilayer magnetic core, each of the c same-saturation-level magnetic layers has a rectangular BH curve. The second multilayer magnetic core of the eighth embodiment is called an eighth multilayer magnetic core in the present invention.

A nineth embodiment based on the third multilayer magnetic core, each of the c same-saturation-level magnetic layers has a rectangular BH curve. The third multilayer magnetic core of the nineth embodiment is called a nineth multilayer magnetic core in the present invention.

A tenth embodiment based on the fourth multilayer magnetic core, each of the c same-saturation-level magnetic layers other than the magnetic layer having a zero-area BH curve has a rectangular BH curve. The fourth multilayer magnetic core of the tenth embodiment is called a tenth multilayer magnetic core in the present invention.

An eleventh embodiment based on the fifth multilayer magnetic core, each of the c same-saturation-level magnetic layers other than the magnetic layer having a zero-area BH curve has a rectangular BH curve. The fifth multilayer magnetic core of the eleventh embodiment is called an eleventh multilayer magnetic core in the present invention.

A twelfth embodiment based on the sixth multilayer magnetic core, each of the c same-saturation-level magnetic layers other than the magnetic layer having a zero-area BH curve has a rectangular BH curve. The seventh multilayer magnetic core of the twelfth embodiment is called a twelfth multilayer magnetic core in the present invention.

An embodiment of the first multilayer magnetic core, the c same-saturation-level magnetic layers are respectively formed with or by a same magnetic material in different grain sizes from each other. The multilayer magnetic core of the embodiment is called a thirteenth multilayer magnetic core in the present invention.

An embodiment of the second multilayer magnetic core, the c same-saturation-level magnetic layers are respectively formed with or by a same magnetic material in different grain sizes from each other. The multilayer magnetic core of the embodiment is called a fourteenth multilayer magnetic core in the present invention.

An embodiment of the third multilayer magnetic core, the c same-saturation-level magnetic layers are respectively formed with or by a same magnetic material in different grain sizes from each other. The multilayer magnetic core of the embodiment is called a fifteenth multilayer magnetic core in the present invention.

An embodiment of the fourth multilayer magnetic core, the c same-saturation-level magnetic layers are respectively formed with or by a same magnetic material in different grain sizes from each other. The multilayer magnetic core of the embodiment is called a sixteenth multilayer magnetic core in the present invention.

An embodiment of the fifth multilayer magnetic core, the c same-saturation-level magnetic layers are respectively formed with or by a same magnetic material in different grain sizes from each other. The multilayer magnetic core of the embodiment is called a seventeenth multilayer magnetic core in the present invention.

An embodiment of the sixth multilayer magnetic core, the c same-saturation-level magnetic layers are respectively formed with or by a same magnetic material in different grain sizes from each other. The multilayer magnetic core of the embodiment is called an eighteenth multilayer magnetic core in the present invention.

An embodiment of the seventh multilayer magnetic core, the c same-saturation-level magnetic layers are respectively formed with or by a same magnetic material in different grain sizes from each other. The multilayer magnetic core of the embodiment is called a nineteenth multilayer magnetic core in the present invention.

An embodiment of the eighth multilayer magnetic core, the c same-saturation-level magnetic layers are respectively formed with or by a same magnetic material in different grain sizes from each other. The multilayer magnetic core of the embodiment is called a twenty multilayer magnetic core in the present invention.

An embodiment of the nineth multilayer magnetic core, the c same-saturation-level magnetic layers are respectively formed with or by a same magnetic material in different grain sizes from each other. The multilayer magnetic core of the embodiment is called a twenty-first multilayer magnetic core in the present invention.

An embodiment of the tenth multilayer magnetic core, the c same-saturation-level magnetic layers are respectively formed with or by a same magnetic material in different grain sizes from each other. The multilayer magnetic core of the embodiment is called a twenty-second multilayer magnetic core in the present invention.

An embodiment of the eleventh multilayer magnetic core, the c same-saturation-level magnetic layers are respectively formed with or by a same magnetic material in different grain sizes from each other. The multilayer magnetic core of the embodiment is called a twenty-third multilayer magnetic core in the present invention.

An embodiment of the twelfth multilayer magnetic core, the c same-saturation-level magnetic layers are respectively formed with or by a same magnetic material in different grain sizes from each other. The multilayer magnetic core of the embodiment is called a twenty-fourth multilayer magnetic core in the present invention.

An embodiment of the thirteenth multilayer magnetic core, the grain sizes are ranged between μm and nm levels. The multilayer magnetic core of the embodiment is called a twenty-fifth multilayer magnetic core in the present invention.

An embodiment of the fourteenth multilayer magnetic core, the grain sizes are ranged between μm and nm levels. The multilayer magnetic core of the embodiment is called a twenty-sixth multilayer magnetic core in the present invention.

An embodiment of the fifteenth multilayer magnetic core, the grain sizes are ranged between μm and nm levels. The multilayer magnetic core of the embodiment is called a twenty-seventh multilayer magnetic core in the present invention.

An embodiment of the sixteenth multilayer magnetic core, the grain sizes are ranged between μm and nm levels. The multilayer magnetic core of the embodiment is called a twenty-eighth multilayer magnetic core in the present invention.

An embodiment of the seventeenth multilayer magnetic core, the grain sizes are ranged between μm and nm levels. The multilayer magnetic core of the embodiment is called a twenty-nineth multilayer magnetic core in the present invention.

An embodiment of the eighteenth multilayer magnetic core, the grain sizes are ranged between μm and nm levels. The multilayer magnetic core of the embodiment is called a thirtieth multilayer magnetic core in the present invention.

An embodiment of the nineteenth multilayer magnetic core, the grain sizes are ranged between μm and nm levels. The multilayer magnetic core of the embodiment is called a thirty-first multilayer magnetic core in the present invention.

An embodiment of the twentieth multilayer magnetic core, the grain sizes are ranged between μm and nm levels. The multilayer magnetic core of the embodiment is called a thirty-second multilayer magnetic core in the present invention.

An embodiment of the twenty-first multilayer magnetic core, the grain sizes are ranged between μm and nm levels. The multilayer magnetic core of the embodiment is called a thirty-third multilayer magnetic core in the present invention.

An embodiment of the twenty-second multilayer magnetic core,the grain sizes are ranged between μm and nm levels. The multilayer magnetic core of the embodiment is called thirty-fourth multilayer magnetic core in the present invention.

An embodiment of the twenty-third multilayer magnetic core, the grain sizes are ranged between μm and nm levels. The multilayer magnetic core of the embodiment is called a thirty-fifth multilayer magnetic core in the present invention.

An embodiment of the twenty-fourth multilayer magnetic core, the grain sizes are ranged between μm and nm levels. The multilayer magnetic core of the embodiment is called thirty-sixth multilayer magnetic core in the present invention.

The e-layer multilayer device for e≧2 described above is an inventive multilayer magnetic core if the e layers of the e-layer multilayer device have f magnetic layers for f≧2 and g same-applied-force magnetic layers for g≧2, where the g same-applied-force magnetic layers are magnetic layers. The BH curve of each of the g same-applied-force magnetic layers is not limited to any particular form, for example, it can be a rectangular or a non-rectangular BH curve. In practice, the same applied force of the g same-applied-force magnetic layers has an allowable varying range.

The e and the f can be equal or different. The e and the f are equal meaning all the layers of the e-layer multilayer device are magnetic layers. The e is larger than the f meaning only a portion of the e layers of the e-layer multilayer device are magnetic layers and the rest of the e layers are not magnetic conductor layers. For example, any two neighboring magnetic layers can be electrically isolated by disposing an electrical isolator layer between the two neighboring magnetic layers if the electrical isolation between two layers is considered. For another example, the multilayer magnetic core can be strengthened by epoxy in the manufacturing process and liquid epoxy in the manufacturing process can possibly infiltrate into two magnetic layers in the form of a layer when dried, which can be viewed as a layer seated between two magnetic layers. If epoxy is an electrical insulator, then it can also function as an electrical isolator seated between two neighboring magnetic layers. The discussion reveals the multilayer magnetic core allows layer other than magnetic layer.

The f and the g can be equal or different. The f and the g are equal meaning all the magnetic layers are same-saturation-level magnetic layers. The f is larger than the g meaning only a portion of the f magnetic layers are same-applied-force magnetic layers and the rest of the f magnetic layers are not same-applied-force magnetic layers or non-same-applied-force magnetic layers, for example, the BH curves respectively of any two of the non-same-applied-force magnetic layers can have different Bs and different Hs. An embodiment, the g same-applied-force magnetic layers can be formed with or by different materials from each other.

An embodiment of the multilayer magnetic core for e=f=g, The multilayer magnetic core of the embodiment is called a thirty-seventh multilayer magnetic core in the present invention.

An embodiment of the multilayer magnetic core for e>f and f=g, The multilayer magnetic core of the embodiment is called a thirty-eighth multilayer magnetic core in the present invention.

An embodiment of the multilayer magnetic core for e>f and f>g, The multilayer magnetic core of the embodiment is called a thirty-nineth multilayer magnetic core in the present invention.

The m-layer multilayer device for m≧2 described above is an inventive multilayer magnetic core if the m layers of the m-layer multilayer device have n magnetic layers for n≧2, c same-saturation-level magnetic layers for c≧1 and g same-applied-force magnetic layers for g≧1, where the c same-saturation-level magnetic layers and the g same-applied-force magnetic layers are magnetic layers. The BH curve of each of the c same-saturation-level magnetic layers is not limited to any particular form, for example, am embodiment, it can be a rectangular or a non-rectangular BH curve. The BH curve of each of the g same-applied-force magnetic layers is not limited to any particular form, for example, an embodiment, it can be a rectangular or a non-rectangular BH curve. In practice, the same saturation level of the c same-saturation-level magnetic layers has an allowable varying range. In practice, the same applied force of the g same-applied-force magnetic layers has an allowable varying range. The c magnetic layers can be respectively formed with or by a same material respectively in different grain sizes below a certain size Louis Neel critical from each other. The c same-saturation-level magnetic layers can have at least a magnetic layer having a zero-area BH curve such as a superparamagnetic material. According to Louis Neel, any applied force on the superparamagnetic material will induce frequency components that will induce extra magnetic fluxes flowing in the multilayer magnetic core to help ease the demand from the applied force. The superparamagnetic material layer advantages to have immediate response to a very small power source that includes a very small DC power. A very small power source such as a small DC can first saturate the uperparamagnetic material and lead to a chain of the immediately multiple saturations. The m and the n can be equal or different. The m and the n are equal meaning all the layers of the m-layer multilayer device are magnetic layers. The m is larger than the n meaning only a portion of the m layers of the m-layer multilayer device are magnetic layers and the rest of the m layers are not magnetic layers or are non-magnetic layers. For example, any two neighboring magnetic layers are electrically isolated by disposing an electrical isolator layer between the two neighboring magnetic layers if the electrical isolation between two magnetic layers is considered. For another example, the multilayer magnetic core can be strengthened by epoxy in the manufacturing process and liquid epoxy in the manufacturing process can possibly infiltrate into two magnetic layers in the form of a layer when dried, which can be viewed as a layer seated between two magnetic layers. If epoxy is an electrical insulator, then it can also function as an electrical isolator seated between two neighboring magnetic layers. The discussion reveals the inventive multilayer magnetic core allows layer other than magnetic layer.

The n and the summation of the c and the g can be equal or different. The n and the summation of the c and the g are equal meaning all the magnetic layers are the same-saturation-level magnetic layers plus the same-applied-force magnetic layers. The n is larger than the summation of the c and the g meaning at least one magnetic layer is not any one of the same-saturation-level magnetic layer and the same-applied-force magnetic layer and the magnetic layer or magnetic layers can be any prior-art magnetic layer.

The c same-saturation-level magnetic layers respectively can have a BH curve with a small H and B and small BH curve area featuring to provide sensitivity but the g same-applied-force magnetic layers and the prior-art magnetic layers can construct a considerate core volume capable of transforming into bigger power so the inventive multilayer magnetic core advantages for having both high sensitivity and high power capability.

When a current from zero provided by a very small electrical power source trying to flow through a conductive coil winding around the inventive multilayer magnetic core has more difficulty to overcome the inductive resistance of the conductive coil so that initially a plurality of intensive saturation attempts one by one in a row can be helpful to gradually jump its current through the multiple saturations. This explains that FIG. 3(A) has also shown more intensive slim BH curves respectively of the c same-saturation-level magnetic layers seen around the center of the B-H coordinates. The intensively multiple saturations one after another jump the current having more capability to overcome the initial inductance resistance.

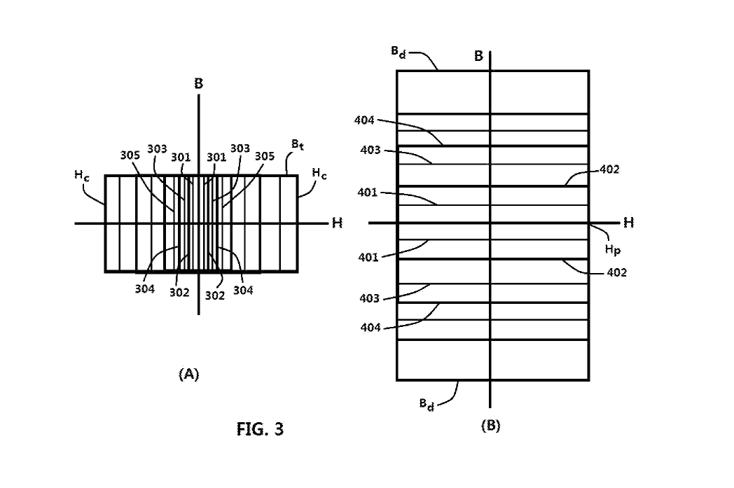

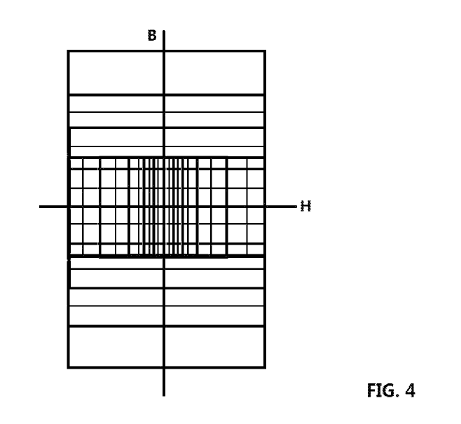

The highest applied force H of the BH curves respectively of the c same-saturation-level magnetic layers can be close to, for example, same or higher than, the applied force H of the BH curves respectively of the g same-applied-force magnetic layers so that when all the c same-saturation-level magnetic layers are saturated the applied force becomes to reach the applied force H of the BH curves respectively of the g same-applied-force magnetic layers capable of immediately saturate all the magnetic layers of the g same-applied-force magnetic layers. FIG. 4 has shown the BH curves respectively of the c same-saturation-level magnetic layers of FIG. 3 (A) and the BH curves respectively of the g same-applied-force magnetic layers of FIG. 3(B) with the highest applied force H of the BH curves respectively of the c same-saturation-level magnetic layers is same to the applied force H of the BH curves respectively of the g same-applied-force magnetic layers or H_{c}=Hₚ. The embodiment of FIG. 4 with H_{c}=Hₚ has featured a very small applied magnetization force such as a small DC can saturate the c same-saturation-level magnetic layers and the g same-applied-force magnetic layers.

An embodiment of the multilayer magnetic core for m=n=c+g. The multilayer magnetic core of the embodiment is called a fortieth multilayer magnetic core in the present invention.

An embodiment of the multilayer magnetic core for m>n and n=c+g. The multilayer magnetic core of the embodiment is called a forty-first multilayer magnetic core in the present invention.

An embodiment of the inventive multilayer magnetic core for m>n and n>c+g. The saturation of the c same-saturation-level magnetic layers can provide sensitivity and the g same-applied-force magnetic layers and the prior-art magnetic layers other than the c same-saturation-level magnetic layers and the g same-applied-force magnetic layers can respectively have bigger area BH curve to construct a considerate core volume capable of transforming into bigger power so the inventive multilayer magnetic core advantages for having both high sensitivity and high power capability. The multilayer magnetic core of the embodiment is called a forty-second multilayer magnetic core in the present invention. The forty-second multilayer magnetic core can be a partial-saturation magnetic core or a full-saturation magnetic core.

An embodiment based on the fortieth multilayer magnetic core, the c same-saturation-level magnetic layers have at least a magnetic layer having a zero-area BH curve such as a superparamagnetic material. According to Louis Neel, any applied force on the superparamagnetic material will induce frequency components that will induce extra magnetic fluxes flowing in the multilayer magnetic core to help ease the demand from the applied force. The superparamagnetic material layer can advantage to have immediate response to a very small power source that includes a very small DC power. A very small power source such as a small DC can first saturate the uperparamagnetic material and lead to a chain of multiple saturations. In other words, a very small power that includes a very small DC power source is capable of saturating the inventive magnetic core with a considerate power. The fortieth multilayer magnetic core of the embodiment is called a forty-third multilayer magnetic core in the present invention.

An embodiment based on the forty-first multilayer magnetic core, the c same-saturation-level magnetic layers have at least a magnetic layer having a zero-area BH curve such as a superparamagnetic material. The forty-first multilayer magnetic core of the embodiment is called a forty-fourth multilayer magnetic core in the present invention.

An embodiment based on the forty-second multilayer magnetic core, the c same-saturation-level magnetic layers have at least a magnetic layer having a zero-area BH curve such as a superparamagnetic material. The multilayer magnetic core of the embodiment is called a forty-fifth multilayer magnetic core in the present invention.

An embodiment based on the fortieth multilayer magnetic core, each of the c same-saturation-level magnetic layers has a rectangular BH curve. The multilayer magnetic core of the embodiment is called a forty-sixth multilayer magnetic core in the present invention.

An embodiment based on the forty-first multilayer magnetic core, each of the c same-saturation-level magnetic layers has a rectangular BH curve. The multilayer magnetic core of the embodiment is called a forty-seventh multilayer magnetic core in the present invention.

An embodiment based on the forty-second multilayer magnetic core, each of the c same-saturation-level magnetic layers has a rectangular BH curve. The multilayer magnetic core of the embodiment is called a forty-eighth multilayer magnetic core in the present invention.

An embodiment based on the forty-third multilayer magnetic core, each of the c same-saturation-level magnetic layers has a rectangular BH curve. The multilayer magnetic core of the embodiment is called a forty-nineth multilayer magnetic core in the present invention.

An embodiment based on the forty-fourth multilayer magnetic core, each of the c same-saturation-level magnetic layers has a rectangular BH curve other than the magnetic layer having zero-area BH curve. The multilayer magnetic core of the embodiment is called a fiftieth multilayer magnetic core in the present invention.

An embodiment based on the forty-fifth multilayer magnetic core, each of the c same-saturation-level magnetic layers has a rectangular BH curve other than the magnetic layer having zero-area BH curve. The multilayer magnetic core of the embodiment is called a fifty-first multilayer magnetic core in the present invention.

An embodiment of the fortieth multilayer magnetic core, the c same-saturation-level magnetic layers are respectively formed with or by a same magnetic material in different grain sizes from each other. The multilayer magnetic core of the embodiment is called a fifty-second multilayer magnetic core in the present invention.

An embodiment of the forty-first multilayer magnetic core, the c same-saturation-level magnetic layers are respectively formed with or by a same magnetic material in different grain sizes from each other. The multilayer magnetic core of the embodiment is called a fifty-third multilayer magnetic core in the present invention.

An embodiment of the forty-second multilayer magnetic core, the c same-saturation-level magnetic layers are respectively formed with or by a same magnetic material in different grain sizes from each other. The multilayer magnetic core of the embodiment is called a fifty-fourth multilayer magnetic core in the present invention.

An embodiment of the forty-third multilayer magnetic core, the c same-saturation-level magnetic layers are respectively formed with or by a same magnetic material in different grain sizes from each other. The multilayer magnetic core of the embodiment is called a fifty-fifth multilayer magnetic core in the present invention.

An embodiment of the forty-fourth multilayer magnetic core, the c same-saturation-level magnetic layers are respectively formed with or by a same magnetic material in different grain sizes from each other. The multilayer magnetic core of the embodiment is called a fifty-sixth multilayer magnetic core in the present invention.

An embodiment of the forty-fifth multilayer magnetic core, the c same-saturation-level magnetic layers are respectively formed with or by a same magnetic material in different grain sizes from each other. The multilayer magnetic core of the embodiment is called an fifty-seventh multilayer magnetic core in the present invention.

An embodiment of the forty-sixth multilayer magnetic core, the c same-saturation-level magnetic layers are respectively formed with or by a same magnetic material in different grain sizes from each other. The multilayer magnetic core of the embodiment is called a fifty-eighth multilayer magnetic core in the present invention.

An embodiment of the forty-seventh multilayer magnetic core, the c same-saturation-level magnetic layers are respectively formed with or by a same magnetic material in different grain sizes from each other. The multilayer magnetic core of the embodiment is called a fifty-nineth multilayer magnetic core in the present invention.

An embodiment of the forty-eighth multilayer magnetic core, the c same-saturation-level magnetic layers are respectively formed with or by a same magnetic material in different grain sizes from each other. The multilayer magnetic core of the embodiment is called a sixtieth multilayer magnetic core in the present invention.

An embodiment of the forty-nineth multilayer magnetic core, the c same-saturation-level magnetic layers are respectively formed with or by a same magnetic material in different grain sizes from each other. The multilayer magnetic core of the embodiment is called a sixty-first multilayer magnetic core in the present invention.

An embodiment of the fifty multilayer magnetic core, the c same-saturation-level magnetic layers are respectively formed with or by a same magnetic material in different grain sizes from each other. The multilayer magnetic core of the embodiment is called a sixty-second multilayer magnetic core in the present invention.

An embodiment of the fifty-first multilayer magnetic core, the c same-saturation-level magnetic layers are respectively formed with or by a same magnetic material in different grain sizes from each other. The multilayer magnetic core of the embodiment is called a sixty-third multilayer magnetic core in the present invention.

An embodiment of the fifty-second multilayer magnetic core, the grain sizes are ranged between μm and nm levels. The multilayer magnetic core of the embodiment is called a sixty-fourth multilayer magnetic core in the present invention.

An embodiment of the fifty-third multilayer magnetic core, the grain sizes are ranged between μm and nm levels. The multilayer magnetic core of the embodiment is called a sixty-fifth multilayer magnetic core in the present invention.

An embodiment of the fifty-fourth multilayer magnetic core, the grain sizes are ranged between μm and nm levels. The multilayer magnetic core of the embodiment is called a sixty-sixth multilayer magnetic core in the present invention.

An embodiment of the fifty-fifth multilayer magnetic core, the grain sizes are ranged between μm and nm levels. The multilayer magnetic core of the embodiment is called a sixty-seventh multilayer magnetic core in the present invention.

An embodiment of the fifty-sixth multilayer magnetic core, the grain sizes are ranged between μm and nm levels. The multilayer magnetic core of the embodiment is called a sixty-eighth multilayer magnetic core in the present invention.

An embodiment of the fifty-seventh multilayer magnetic core, the grain sizes are ranged between μm and nm levels. The multilayer magnetic core of the embodiment is called a sixty-nineth multilayer magnetic core in the present invention.

An embodiment of the fifty-eighth multilayer magnetic core, the grain sizes are ranged between μm and nm levels. The multilayer magnetic core of the embodiment is called a seventieth multilayer magnetic core in the present invention.

An embodiment of the fifty-nineth multilayer magnetic core, the grain sizes are ranged between μm and nm levels. The multilayer magnetic core of the embodiment is called a seventy-first multilayer magnetic core in the present invention.

An embodiment of the sixtieth multilayer magnetic core, the grain sizes are ranged between μm and nm levels. The multilayer magnetic core of the embodiment is called a seventy-second multilayer magnetic core in the present invention.

An embodiment of the sixty-first multilayer magnetic core,the grain sizes are ranged between μm and nm levels. The multilayer magnetic core of the embodiment is called a seventy-third multilayer magnetic core in the present invention.

An embodiment of the sixty-second multilayer magnetic core, the grain sizes are ranged between μm and nm levels. The multilayer magnetic core of the embodiment is called a seventy-fourth multilayer magnetic core in the present invention.

An embodiment of the sixty-third multilayer magnetic core, the grain sizes are ranged between μm and nm levels. The multilayer magnetic core of the embodiment is called a seventy-fifth multilayer magnetic core in the present invention.

At least a conductive coil winding around one of the first, the second, the third, the fourth, the fifth, the sixth, the seventh, the eighth, the nineth, the tenth, the eleventh, the twelfth, the thirdteenth, the fourteenth, the fifteenth, the sixteenth, the seventeenth, the eighteen, the nineteenth, the twentieth, the twenty-first, the twenty-second, the twenty-third, the twenty-fourth, the twenty-fifth, the twenty-sixth, the twenty-seventh, the twenty-eighth, the twenty-nineth, the thirtieth, the thirty-first, the thirty-second, the thirty-third, the thirty-fourth, thirty-fifth, and the thirty-sixth multilayer magnetic cores and one of the thirty-seventh, thirty-eighth, and the thirty-nineth multilayer magnetic cores to form an inventive inductor with the highest applied force H of the BH curves respectively of the c same-saturation-level magnetic layers is close to, for example, same or higher than, the applied force H of the BH curves respectively of the g same-applied-force magnetic layers.

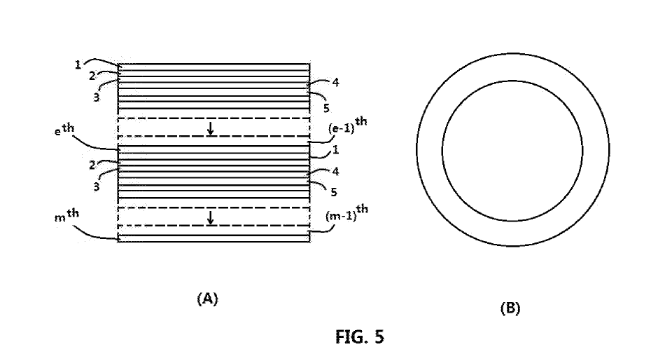

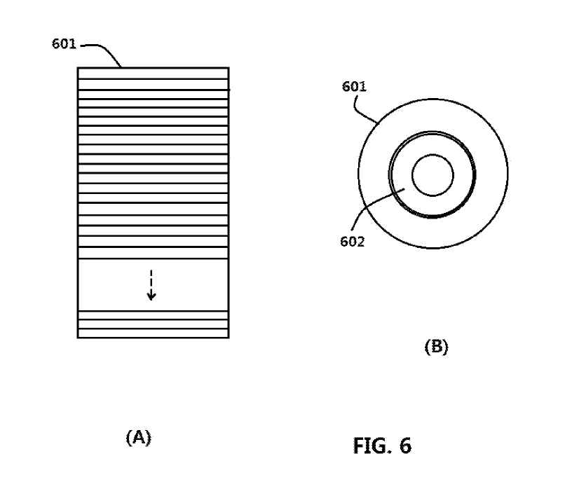

The two multilayer magnetic cores wound by the conductive coil can be stacked together with one multilayer magnetic core laying on the other multilayer magnetic core or a smaller one multilayer magnetic core disposed inside a larger multilayer magnetic core, for example, FIG. 5(A) has shown an embodiment with two cylindrical multilayer magnetic cores stacked together in side view with one topping on the other one. FIG. 5(B) is a top view of FIG. 5(A). FIG. 6(A) has shown an embodiment with a smaller cylindrical multilayer magnetic core 602 disposed inside a larger cylindrical multilayer magnetic cores 601 in side view. FIG. 6(B) is the top view of FIG. 6(A).

For simplicity, the first, the second, the third, the fourth, the fifth, the sixth, the seventh, the eighth, the nineth, the tenth, the eleventh, the twelfth, the thirdteenth, the fourteenth, the fifteenth, the sixteenth, the seventeenth, the eighteen, the nineteenth, the twentieth, the twenty-first, the twenty-second, the twenty-third, the twenty-fourth, the twenty-fifth, the twenty-sixth, the twenty-seventh, the twenty-eighth, the twenty-nineth, the thirtieth, the thirty-first, the thirty-second, the thirty-third, the thirty-fourth, thirty-fifth, and the thirty-sixth multilayer magnetic cores can also be simply expressed by “the first-the thirty-sixth multilayer magnetic cores”.

The thirty-seventh, the thirty-eighth and the thirty-nineth multilayer magnetic cores can also simply be expressed by the thirty-seventh-the thirty-nineth multilayer magnetic cores.

At least a conductive coil winding around each of the first-the seventh-fifth multilayer magnetic cores respectively forms an inventive inductor.

When only a portion of the magnetic layers of a multilayer magnetic core are saturated by a current flowing through a conductive coil winding around the magnetic core or a nearby magnetic field, the multilayer magnetic core is called partial-saturation multilayer magnetic core in the present invention. When all the magnetic layers of a multilayer magnetic core are saturated by a current flowing through a conductive coil winding around the magnetic core or a nearby magnetic field, the multilayer magnetic core is called full-saturation multilayer magnetic core in the present invention. When all the magnetic layers of a multilayer magnetic core are saturated by a current flowing through a conductive coil winding around the magnetic core, its inductance drops from a non-zero number to zero in theory. The characteristics can be used to construct a switch and an magnetic amplifier.

The insulated-gate bipolar transistor (IGBT) is a three-terminal power semiconductor device primarily used as an electronic switch. The prior-art IGBT has drawbacks: (1) the junction of IGBT is weak against big electrical power flowing through it and the problem is getting worse for continous big electrical power, (2) a waveform applied on the gate of IGBT to control on/off of the IGBT will be modulated into the electrical power flowing through the IGBT as a noise, (3) it's difficult to precisely turn on or off an IGBT, (4) a serious heat will be accumulated in the IGBT and the heat dissipation is critical, (5) IGBT is expensive, and (6) a waveform applied on the gate of IGBT to control the IGBT usually has negative voltage causing many potential problems to the circuit and design difficulties.

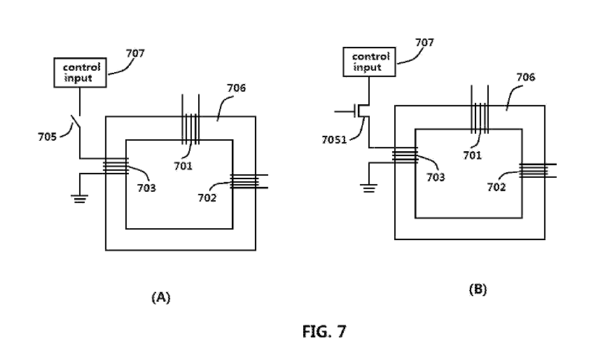

FIG. 7(A) has shown a first coil 701, a second coil 702 and a third coil 703 respectively winding around a magnetic core 706 in top view with a switch 705 to control a current if flowing through the third coil 703.

When the switch 705 is in open state, current from a control input 707 can not flow through the third coil 703 and the inductor of FIG. 7(A) can be viewed as a transformer so an electrical power flowing through the first coil 701 will induce an electrical power at the second coil 702, which is in analogy to the “gate-on” of transistor such as IGBT. When the switch 705 is in close state, current from the control input 707 will flow through the third coil 703 to saturate the magnetic core 706 to drop its inductance to zero and an electrical power flowing through the first coil 701 will not induce an electrical power at the second coil 702 at the moment, which is in analogy to the “gate-off” of transistor such as IGBT. The current if flowing through the third coil 703 controls the switching between the gate-on and gate-off. The magnetic core volume and its BH curve decide the power capability of the transformer. The switch 705 of FIG. 7(A) is not limited to any particular switch, for example, the switch 705 can be a transistor 7051 such as MOSFET as shown in FIG. 7(B) and the MOSFET can be controlled by a waveform applied on its gate.

The magnetic core 706 of the inventive magnetic switch of FIG. 7 can be a full-saturation magnetic core. The magnetic core 706 of FIG. 7 can be any one of the inventive full-satuartion first-the seventy-fifteenth multilayer magnetic cores to reveal an inventive magnetic switch. For example, assuming the magnetic core 706 is the inventive fiftieth multilayer magnetic core, then a very small applied magnization force from the control input 707 can fully saturate the fiftieth multilayer magnetic core in zero-wait, which reveals an inventive magnetic switch featuring to have both sensitivity and power capability. One of the application, the inventive magnetic switch can be used to function as an IGBT having some advantages: (1) the three conductive coils 701, 702 and 703 are electrically isolated from each other providing more safety, (2) the inventive magnetic switch can have both sensitivity and power capability, (3) a very small electrical power can control the on/off switch of a very big power, which is safe, (4) there is less heat problem compared to that of IGBT, and (5) the on/off switching of the inventive magnetic switch can be precisely controlled.

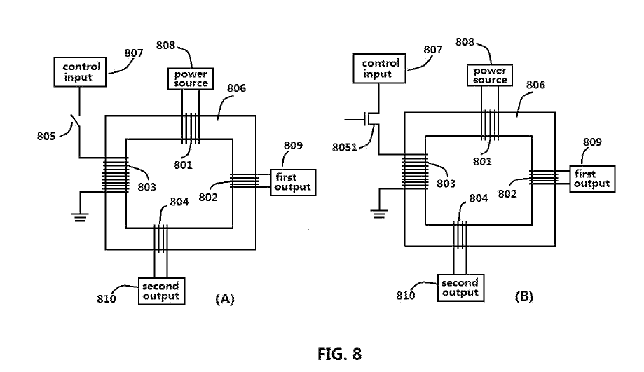

FIG. 8 has also shown an inventive magnetic amplifier. FIG. 8(A) has shown a first coil 801, a second coil 802 and a third coil 803 respectively winding around a magnetic core 806 in top view with a switch 805 to control a current from a control input 807 if flowing through the third coil 803. The switch 805 of FIG. 8(A) is not limited to any particular switch, for example, the switch 805 can be a transistor 8051 such as MOSFET as shown in FIG. 8(B) and the MOSFET can be controlled by a waveform applied on its gate.

The magnetic core 806 of the magnetic amplifier of FIG. 8 can be any one of the inventive first-the seventy-fifteenth multilayer magnetic cores to reveal an inventive magnetic amplifier. Current flowing through the transistor 8051 saturates at least a magnetic layer to drop the inductance of the third coil 803 so an electrical power source 808 flowing through the first coil 801 will be amplified at a first output 809 taken at the second coil 802 winding around the magnetic core 806. Assuming the first coil 801, the second coil 802, and the third coil 803 respectively have n₁ coil turns, n₂ coil turns, and n₃ coil turns. A first embodiment for the inventive magnetic amplifier, n₃>n₁, and n₃>n₂, a second embodiment for the inventive magnetic amplifier, the coil turn ratio respectively as n₃/n₁ and n₃/n₂ can respectively be high to an order of 10² or 10³ for obtaining better performance. The inventive magnetic amplifier of FIG. 8 can be a partial-saturation or a full-saturation magnetic core.

If the magnetic core 806 has more space, then a fourth coil 804 can wind around the magnetic core 806 to obtain a second output 810 taken at the fourth coil 804. The inventive magnetic amplifier allows more than one output.

An embodiment, each magnectic core in our previous still-in-processing patent “Power Boost Circuit” with its application Ser. No. 14/056,980, filed on 18 Oct. 2013, can be any one of the first-the seventy-fifteenth multilayer magnetic cores revealed in the present invention.

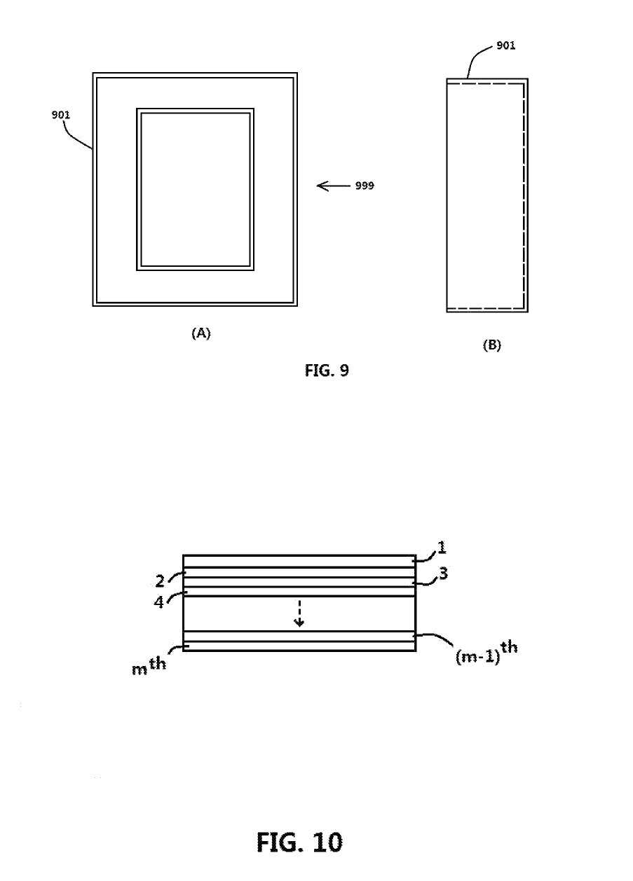

An inventive a first manufacturing method to manufacture the inventive multilayer magnetic core is revealed. FIG. 9(A) has shown a container 901 in top view and FIG. 9(B) has shown the container 901 of FIG. 9(A) in side view with its viewed direction shown by an arrow 999. The container 901 has temperature control capability such as preheat, heat-up and heat-down capabilities.

A burning molten first material at a first temperature can be poured into the container 901 at a second temperature to proceed a first annealing process to form a first magnetic layer in a first grain size. The first annealing process is the major process deciding the first grain size. A first electrical isolator layer is disposed or formed on the first magnetic layer. A burning molten second material at a third temperature can be poured into the container 901 at a fourth temperature on the first electrical isolator layer to proceed a second annealing process to form a second magnetic layer in a second grain size. The second annealing process is the major process deciding the second grain size. A second electrical isolator layer is disposed or formed on the second magnetic layer. A burning molten third material at a fifth temperature can be poured into the container 901 at a sixth temperature on the second electrical isolator layer to proceed a third annealing process to form a third magnetic layer in a third grain size. The third annealing process is the major process deciding the third grain size. The process repeats by the logic to form multiple magnetic layers or multilayer magnetic core.

Any two of the first material, the second material and the third material can be identical or different. Any two of the first annealing process, the second annealing process and the third annealing process can be identical or different. Any two of the first temperature, the second temperature, the third temperature, the fourth temperature, the fifth temperature and the sixth temperature can be identical or different. Any two of the first grain size, the second grain size and the third grain size can be identical or different. Any two of the thicknesses respectively of the first magnetic layer, the second magnetic layer and the third magnetic layer can be identical or different.

The electrical isolator layer is not needed if the electrical isolation between two magnetic layers is not considered, if this is the case, a burning molten second material at a third temperature can be poured into the container 901 at a fourth temperature on the first magnetic layer to proceed a second annealing process to form a second magnetic layer in a second grain size. The process repeats by the logic to form the multiple magnetic layers or multilayer magnetic core.

A second manufacturing method to manufacture the inventive multilayer magnetic core is also revealed. A first magnetic material has been annealed in the form of powders in a first grain size. The powders in the first grain size can be evenly mixed with a first liquid material such as epoxy to form a first magnetic layer. A first electrical isolator layer is disposed or formed on the first magnetic layer. A second magnetic material has been annealed in the form of powders in a second grain size. The powders in a second grain size can be evenly mixed with a second liquid material such as epoxy to be poured on the first electrical isolator layer to form a second magnetic layer on the first electrical isolator layer. Then, a second electrical isolator layer is disposed or formed on the second magnetic layer. A third magnetic material has been annealed in the form of powders in a third grain size. The powders in a third grain size can be evenly mixed with a third liquid material such as epoxy to be poured on the second electrical isolator layer to form a third magnetic layer on the second electrical isolator layer. The process repeats by the logic to form multiple magnetic layers or multilayer magnetic core.

Any two of the first magnetic material, the second magnetic material and the third magnetic material can be identical or different. Any two of the first grain size, the second grain size and the third grain size can be identical or different. Any two of the first liquid material, the second liquid material and the third liquid material can be identical or different. Any two of the thicknesses respectively of the first magnetic layer, the second magnetic layer and the third magnetic layer can be identical or different.

The electrical isolator layer is not needed if the electrical isolation between two magnetic layers is not considered, if this is the case, the powders in a second grain size can be evenly mixed with a second liquid material such as epoxy to be poured on the first magnetic layer to form a second magnetic layer on the first magnetic layer. The process repeats to form a third magnetic layer on the second magnetic layer.

1. A multilayer magnetic core, comprising:
a plurality of same-saturation-level magnetic layers respectively having a BH curve, wherein BH curves respectively of the plurality of same-saturation-level magnetic layers have a same saturation level and different applied magnization forces from each other.

2. The multilayer magnetic core of claim 1, wherein the BH curves respectively of the plurality of same-saturation-level magnetic layers densely populate around the center of the B-H coordinates for jumping current flowing through a conductive coil winding around the multilayer magnetic core through multiple saturations to overcome an inductive resistance of the conductive coil.

3. The multilayer magnetic core of claim 1, wherein the plurality of same-saturation-level magnetic layers are respectively formed with a same material respectively in different grain sizes.

4. The multilayer magnetic core of claim 2, wherein the plurality of same-saturation-level magnetic layers are respectively formed with a same material respectively in different grain sizes.

5. The multilayer magnetic core of claim 4, wherein the grain sizes are between μm and nm levels.

6. The multilayer magnetic core of claim 1, wherein at least a magnetic layer has a zero-area BH curve.

7. The multilayer magnetic core of claim 2, wherein at least a magnetic layer has a zero-area BH curve.

8. The multilayer magnetic core of claim 3, wherein at least a magnetic layer has a zero-area BH curve.

9. The multilayer magnetic core of claim 4, wherein at least a magnetic layer has a zero-area BH curve.

10. The multilayer magnetic core of claim 5, wherein at least a magnetic layer has a zero-area BH curve.

11. The multilayer magnetic core of claim 4, wherein each of the plurality of same-saturation-level magnetic layers has a rectangular BH curve.

12. The multilayer magnetic core of claim 5, wherein each of the plurality of same-saturation-level magnetic layers has a rectangular BH curve.

13. The multilayer magnetic core of claim 8, wherein each of the plurality of same-saturation-level magnetic layers has a rectangular BH curve.

14. The multilayer magnetic core of claim 9, wherein each of the plurality of same-saturation-level magnetic layers has a rectangular BH curve.

15. The multilayer magnetic core of claim 1, further comprising a plurality of same-applied-force magnetic layers respectively having a BH curve, wherein BH curves respectively of the plurality of same-applied-force magnetic layers have a same applied magnization force and different saturation levels from each other, and a highest applied force of the BH curves respectively of the same-saturation-level magnetic layers is close to an applied force of the BH curves respectively of the same-applied-force magnetic layers so when all the same-saturation-level magnetic layers are saturated by a current flowing through a conductive coil winding around the multilayer magnetic core the applied magnetization force at the moment saturates all the same-applied-force magnetic layers.

16. The multilayer magnetic core of claim 4, further comprising a plurality of same-applied-force magnetic layers respectively having a BH curve, wherein BH curves respectively of the plurality of same-applied-force magnetic layers have a same applied magnization force and different saturation levels from each other, and a highest applied force of the BH curves respectively of the same-saturation-level magnetic layers is close to an applied force of the BH curves respectively of the same-applied-force magnetic layers so when all the same-saturation-level magnetic layers are saturated by a current flowing through a conductive coil winding around the multilayer magnetic core the applied magnetization force at the moment saturates all the same-applied-force magnetic layers.

17. The multilayer magnetic core of claim 10, further comprising a plurality of same-applied-force magnetic layers respectively having a BH curve, wherein BH curves respectively of the plurality of same-applied-force magnetic layers have a same applied magnization force and different saturation levels from each other, and a highest applied force of the BH curves respectively of the same-saturation-level magnetic layers is close to an applied force of the BH curves respectively of the same-applied-force magnetic layers so when all the same-saturation-level magnetic layers are saturated by a current flowing through a conductive coil winding around the multilayer magnetic core the applied magnetization force at the moment saturates all the same-applied-force magnetic layers.

18. The multilayer magnetic core of claim 14, further comprising a plurality of magnetic layers respectively having a BH curve, wherein BH curves respectively of any two magnetic layers have different applied magnezation forces and saturation levels.

19. The multilayer magnetic core of claim 16, further comprising a plurality of magnetic layers respectively having a BH curve, wherein BH curves respectively of any two magnetic layers have different applied magnezation forces and saturation levels.

20. The multilayer magnetic core of claim 17, further comprising a plurality of magnetic layers respectively having a BH curve, wherein BH curves respectively of any two magnetic layers have different applied magnezation forces and saturation levels.
